(19) United States
(12) Patent Application Publication
(10) Pub. No.: US 2017/0339507 A1
(43) Pub. Date: Nov. 23, 2017

(54) SYSTEMS AND METHODS FOR ADJUSTING DIRECTIONAL AUDIO IN A 360 VIDEO

(71) Applicant: CyberLink Corp., Shindian City (TW)

(72) Inventor: Chao-Hsien HSU, Taipei City (TW)

(21) Appl. No.: 15/591,339

(22) Filed: May 10, 2017

Related U.S. Application Data
(60) Provisional application No. 62/337,912, filed on May 18, 2016.

(51) Int. Cl. H04S 7/00; H04N 13/00

(52) U.S. Cl. CPC H04S 7/303; H04N 13/0055; H04S 2420/11; H04S 2400/01

(57) ABSTRACT

In a computing device for adjusting audio output during playback of 360 video, a 360 video bitstream is received, and the 360 video bitstream separated into video content and audio content. The audio content corresponding to a plurality of audio sources is decoded, wherein a number of audio sources is represented by N. The video content is displayed and the audio content is output through a plurality of output devices, wherein a number of output devices is represented by M. In response to detecting a change in a viewing angle for the video content, a determination is made, for each of the plurality of output devices, of a distribution ratio for each of the plurality of audio sources based on the viewing angle such that N×M distribution ratios are determined; and the audio content is output through each of the plurality of output devices based on the determined N×M distribution ratios.

### CROSS-REFERENCE TO RELATED APPLICATION

This application claims priority to, and the benefit of, U.S. Provisional patent application entitled, “Systems and Methods for Adjusting Directional Audio in a 360 Video,” having Ser. No. 62/337,912, filed on May 18, 2016, which is incorporated by reference in its entirety.

### TECHNICAL FIELD

The present disclosure generally relates to audio processing and more particularly, to systems and methods for adjusting directional audio according to a viewing angle during playback of a 360 video.

### BACKGROUND

As smartphones and other mobile devices have become ubiquitous, people have the ability to capture video virtually anytime. Furthermore, 360 videos have gained increasing popularity.

### SUMMARY

In a computing device for adjusting audio output during playback of 360 video, a 360 video bitstream is received, and the 360 video bitstream separated into video content and audio content. The audio content corresponding to a plurality of audio sources is decoded, wherein a number of audio sources is represented by N. The video content is displayed and the audio content is output through a plurality of output devices, wherein a number of output devices is represented by M. In response to detecting a change in a viewing angle for the video content, a determination is made, for each of the plurality of output devices, of a distribution ratio for each of the plurality of audio sources based on the viewing angle such that N×M distribution ratios are determined; and the audio content is output through each of the plurality of output devices based on the determined N×M distribution ratios.

Another embodiment is a system that comprises a memory storing instructions and a processor coupled to the memory. The processor is configured by the instructions to receive a 360 video bitstream, and separate the 360 video bitstream into video content and audio content. The processor is further configured to decode the audio content corresponding to a plurality of audio sources, wherein a number of audio sources is represented by N. The processor is further configured to display the video content and output the audio content through a plurality of output devices, wherein a number of output devices is represented by M. In response to detecting a change in a viewing angle for the video content, the processor is further configured to determine, for each of the plurality of output devices, a distribution ratio for each of the plurality of audio sources based on the viewing angle such that N×M distribution ratios are determined; and output the audio content through each of the plurality of output devices based on the determined N×M distribution ratios.

Another embodiment is a non-transitory computer-readable storage medium storing instructions to be implemented by a computing device having a processor. The instructions, when executed by the processor, cause the computing device to receive a 360 video bitstream, and separate the 360 video bitstream into video content and audio content. The computing device is further configured to decode the audio content corresponding to a plurality of audio sources, wherein a number of audio sources is represented by N. The computing device is further configured to display the video content and output the audio content through a plurality of output devices, wherein a number of output devices is represented by M. In response to detecting a change in a viewing angle for the video content, the computing device is further configured to determine, for each of the plurality of output devices, a distribution ratio for each of the plurality of audio sources based on the viewing angle such that N×M distribution ratios are determined; and output the audio content through each of the plurality of output devices based on the determined N×M distribution ratios.

### BRIEF DESCRIPTION OF THE DRAWINGS

Various aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of a computing device 102 in which distribution of audio content from a plurality of audio sources to different channels of an audio output device may be implemented in accordance with various embodiments.

FIG. 2 illustrates a schematic block diagram of the computing device 102 in FIG. 1 in accordance with various embodiments.

FIG. 3 is a flowchart for distributing the audio content from a plurality of audio sources to different channels of an audio output device utilizing the computing device 102 of FIG. 1 in accordance with various embodiments.

FIG. 4 illustrates placement of a plurality of audio capture devices for capturing audio content corresponding to a plurality of audio sources.

FIG. 5 illustrates calculation of the ratio for different viewing angles and for different numbers of audio sources in accordance with various embodiments.

FIG. 6 illustrates calculation of the ratio for two audio sources in accordance with various embodiments.

FIG. 7 illustrates calculation of the ratio for three audio sources in accordance with various embodiments.

FIG. 8 illustrates calculation of the ratio for four audio sources in accordance with various embodiments.

FIG. 9 illustrates calculation of the ratio for three audio sources for distribution to three audio output devices in accordance with various embodiments.

### DETAILED DESCRIPTION

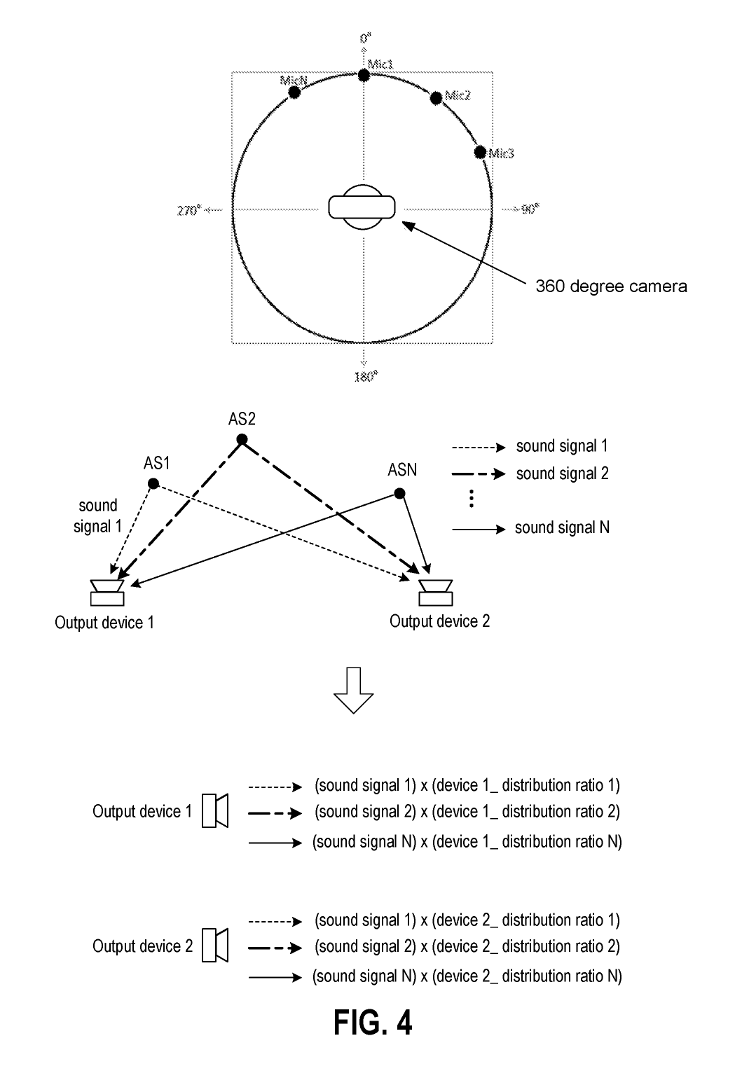

An increasing number of digital capture devices are capable of recording 360 degree video (hereinafter “360 video”), which offers viewers a fully immersive experience. The creation of 360 video generally involves capturing a full 360 degree view using multiple cameras, stitching the captured views together, and encoding the video. An individual viewing a 360 video can experience audio from multiple directions due to placement of various audio capture devices during capturing of 360 video, as shown in FIG. 4. Various embodiments achieve an improved audio experience over conventional systems by adjusting the perceived direction of audio according to the user's viewing angle during playback of 360 video, thereby providing the user with a more realistic experience. In this regard, various embodiments provide an improvement over systems that output the same audio content regardless of whether the viewing angle changes.

As shown in FIG. 4, each audio source (AS1, AS2, . . . ASN) generates a corresponding sound signal (sound signal 1, sound signal 2, . . . sound signal N) that is output through each of the output devices. Two output devices (output device 1, output device 2) are shown in the example configuration of FIG. 4. Note, however, that any number of output devices (M) may be implemented. As further shown in FIG. 4, each sound signal (sound signal 1, sound signal 2, . . . sound signal N) is weighted by a corresponding distribution ratio and output through each output device (output device 1, output device 2), where the distribution ratio affects the magnitude or volume in which the corresponding sound signal is output through the output device. Each distribution ratio is determined based on which device (output device 1 or output device 2) for outputting the sound signal and based on the viewing angle specified by the user, as described in more detail below.

It should be emphasized that the present invention does not limit how the microphones are connected to the camera. Each audio source (AS) provides a separate sound signal based on the audio content captured by a corresponding microphone. For example, AS1 produces a sound signal based on the sound signal captured by Mic1. The microphone configuration utilized while capturing 360 video can be designed to accommodate different camera designs. For example, the microphone can be coupled via a cable or coupled wirelessly to the camera via Bluetooth®. In some configurations, a microphone array can be attached directly below or above the video camera to capture audio from different directions. The microphones can be evenly located around the camera or randomly placed.

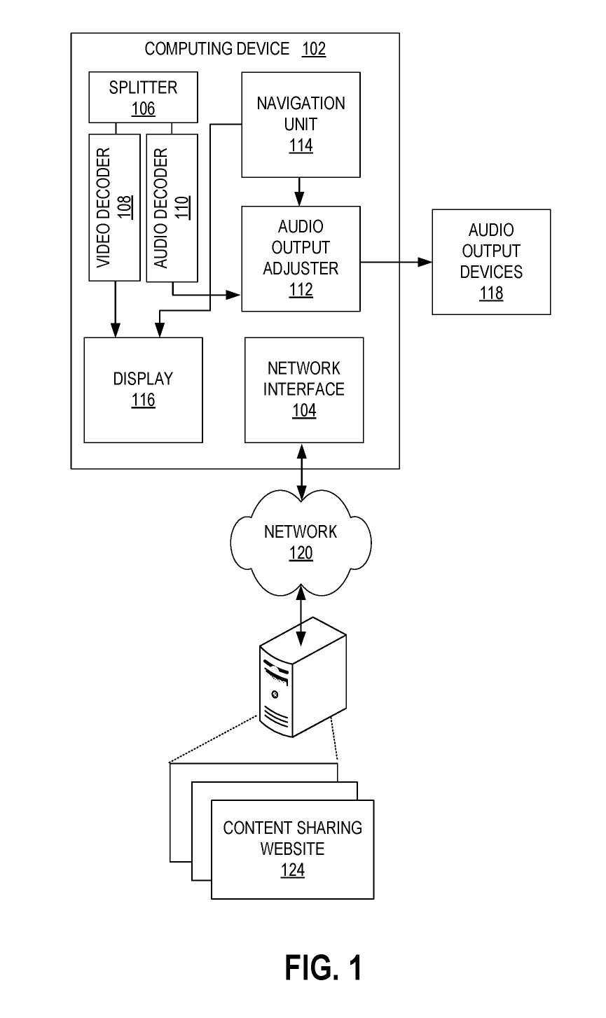

A description of a system for implementing the audio adjustment techniques disclosed herein is now described followed by a discussion of the operation of the components within the system. FIG. 1 is a block diagram of a computing device 102 in which the algorithms disclosed herein may be implemented. The computing device 102 may be embodied as a computing device 102 equipped with digital content recording capabilities, where the computing device 102 may include, but is not limited to, a digital camera, a smartphone, a tablet computing device, a digital video recorder, a laptop computer coupled to a webcam, and so on.

For some embodiments, the computing device 102 may be equipped with a plurality of cameras (not shown) where the cameras are utilized to directly capture digital media content comprising 360 degree views. In accordance with such embodiments, the computing device 102 further comprises a stitching module (not shown) configured to process the captured views and generate a 360 degree video. Alternatively, the computing device 102 can obtain 360 video from other digital recording devices coupled to the computing device 102 through a network interface 104. The network interface 104 in the computing device 102 may also access one or more content sharing websites 124 hosted on a server via the network 120 to retrieve digital media content.

As one of ordinary skill will appreciate, the digital media content may be encoded in any of a number of formats including, but not limited to, Motion Picture Experts Group (MPEG)-1, MPEG-2, MPEG-4, H.264, Third Generation Partnership Project (3GPP), 3GPP-2, Standard-Definition Video (SD-Video), High-Definition Video (HD-Video), Digital Versatile Disc (DVD) multimedia, Video Compact Disc (VCD) multimedia, High-Definition Digital Versatile Disc (HD-DVD) multimedia, Digital Television Video/High-definition Digital Television (DTV/HDTV) multimedia, Audio Video Interleave (AVI), Digital Video (DV), QuickTime (QT) file, Windows Media Video (WMV), Advanced System Format (ASF), Real Media (RM), Flash Media (FLV), or any number of other digital formats.

The computing device 102 includes a splitter 106 for receiving a 360 video file and separating the 360 video file into video and audio content. The splitter 106 routes the video content to a video decoder 108 and the audio content to an audio decoder 110 for decoding the video and audio data inside the file, respectively. The video decoder 108 is coupled to a display 116 and the audio decoder 110 is coupled to an audio output adjuster 112. As described in more detail below, the audio output adjuster 112 is configured to determine a ratio for distributing audio content from each of the audio sources (AS1, AS2, . . . ASN) (FIG. 4) corresponding to audio content captured by the corresponding audio capture sources.

For embodiments where the audio output device 118 in FIG. 1 comprises headphones or a two-device setup (e.g., a left channel speaker and a right channel speaker), the audio output adjuster 112 is configured to calculate a ratio for distributing content from each of the audio sources between the left and right channels. The navigation unit 114 receives input from the user for specifying the viewing angle for viewing the 360 video. The user input may be generated by manipulating a navigation tool such as virtual reality (VR) headset, dragging a mouse, dragging a finger across a touchscreen display, using an accelerometer and/or other sensors on the computing device 102, and so on. Data such as the viewing angle received by the navigation unit 114 is then routed to the audio output adjuster 112 and the display 116. Various embodiments thus achieve an improved audio experience by adjusting the perceived direction of audio according to the user's viewing angle during playback of 360 video.

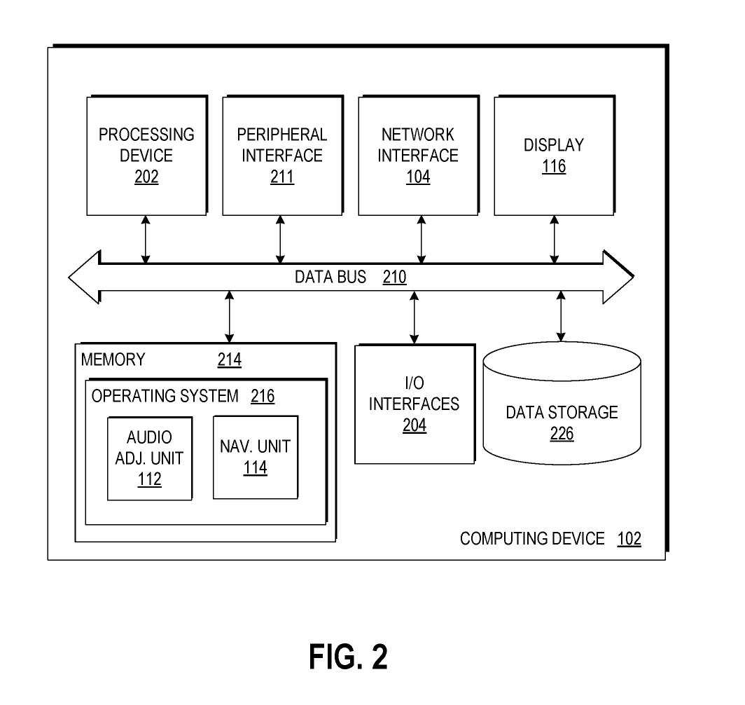

FIG. 2 illustrates a schematic block diagram of the computing device 102 in FIG. 1. The computing device 102 may be embodied in any one of a wide variety of wired and/or wireless computing device 102s, such as a desktop computer, portable computer, dedicated server computer, multiprocessor computing device, smart phone, tablet, and so forth. As shown in FIG. 2, each of the computing device 102 comprises memory 214, a processing device 202, a number of input/output interfaces 204, a network interface 104, a display 116, a peripheral interface 211, and mass storage 226, wherein each of these components are connected across a local data bus 210.

The processing device 202 may include any custom made or commercially available processor, a central processing unit (CPU) or an auxiliary processor among several processors associated with the computing device 102, a semiconductor based microprocessor (in the form of a microchip), a macroprocessor, one or more application specific integrated circuits (ASICs), a plurality of suitably configured digital logic gates, and other well known electrical configurations comprising discrete elements both individually and in various combinations to coordinate the overall operation of the computing system.

The memory 214 can include any one of a combination of volatile memory elements (e.g., random-access memory (RAM, such as DRAM, and SRAM, etc.)) and nonvolatile memory elements (e.g., ROM, hard drive, tape, CDROM, etc.). The memory 214 typically comprises a native operating system 216, one or more native applications, emulation systems, or emulated applications for any of a variety of operating systems and/or emulated hardware platforms, emulated operating systems, etc. For example, the applications may include application specific software which may comprise some or all the components of the computing device 102 depicted in FIG. 1. In accordance with such embodiments, the components are stored in memory 214 and executed by the processing device 202. One of ordinary skill in the art will appreciate that the memory 214 can, and typically will, comprise other components which have been omitted for purposes of brevity.

Input/output interfaces 204 provide any number of interfaces for the input and output of data. For example, where the computing device 102 comprises a personal computer, these components may interface with one or more user input/output interfaces, which may comprise a keyboard or a mouse, as shown in FIG. 2. The display 116 104 may comprise a computer monitor, a plasma screen for a PC, a liquid crystal display (LCD) on a hand held device, a touchscreen, or other display 116 device.

In the context of this disclosure, a non-transitory computer-readable medium stores programs for use by or in connection with an instruction execution system, apparatus, or device. More specific examples of a computer-readable medium may include by way of example and without limitation: a portable computer diskette, a random access memory (RAM), a read-only memory (ROM), an erasable programmable read-only memory (EPROM, EEPROM, or Flash memory), and a portable compact disc read-only memory (CDROM) (optical).

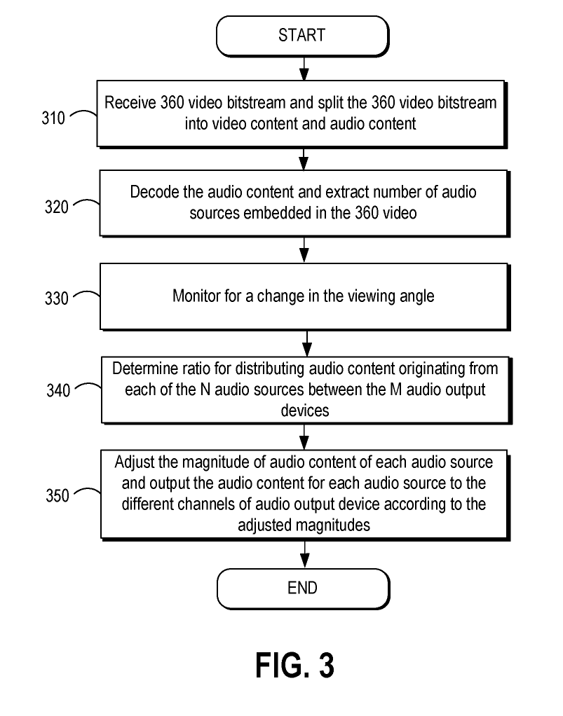

Reference is made to FIG. 3, which is a flowchart in accordance with various embodiments for encoding 360 video performed by the computing device 102 of FIG. 1. It is understood that the flowchart of FIG. 3 provides merely an example of the different types of functional arrangements that may be employed to implement the operation of the various components of the computing device 102. As an alternative, the flowchart of FIG. 3 may be viewed as depicting an example of steps of a method implemented in the computing device 102 according to one or more embodiments.

Although the flowchart of FIG. 3 shows a specific order of execution, it is understood that the order of execution may differ from that which is depicted. For example, the order of execution of two or more blocks may be scrambled relative to the order shown. Also, two or more blocks shown in succession in FIG. 3 may be executed concurrently or with partial concurrence. It is understood that all such variations are within the scope of the present disclosure.

To begin, in block 310, the computing device 102 receives 360 video to be viewed by a user and splits the 360 video into video and audio content. In block 320, the audio decoder 110 decodes the encoded audio content and extracts the number of audio sources (AS1 to ASN) encoded in the audio portion of the 360 video, where N represents the total number of audio sources. As shown earlier in FIG. 1, the number of audio sources corresponds to the number of audio recording devices utilized in conjunction with a 360 video camera for capturing the 360 video content.

Next, in block 330, the computing device 102 monitors for a change in viewing angle specified by the user as the user views the 360 video. A change in the viewing angle by the user triggers calculation of the ratio for distributing audio content from each of the N audio sources to the channels of the audio output device, and adjustment of the audio output is performed on the fly. For implementations where the audio output device comprises headphones, the headphones comprise a right channel and a left channel such that the number of audio output devices is two (M=2).

The computing device 102 determines the ratio for distributing audio content originating from each of the N audio sources between the M=2 audio output devices—specifically, between the left and right channels of the headphones (block 340). Thus, the ratio is calculated for each of the N audio sources, thereby yielding N ratio values for each of the M=2 audio output devices for a total of N×M ratio values. Based on the determined ratio, in block 350, the computing device 102 adjusts the corresponding magnitude or volume of the audio content for the left and right channels for each of the N audio sources and outputs the audio content accordingly to the left and right channels. Thereafter the process in FIG. 3 ends.

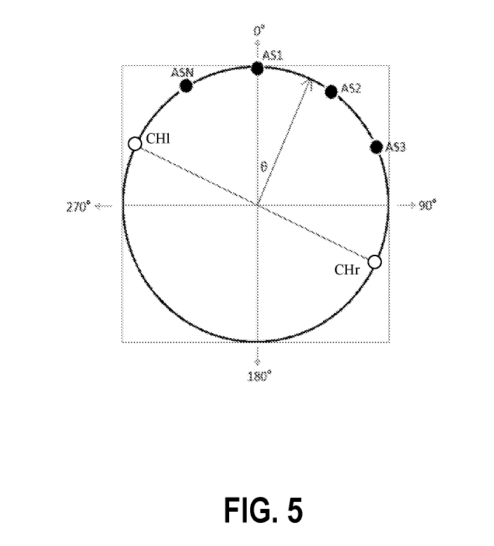

Additional details are now provided for calculation of distribution ratios by the audio output adjuster 112 (FIG. 1). Reference is made to FIG. 5, which illustrates derivation of the distribution ratios for audio content originating from N audio sources (AS1, AS2, AS3, . . . , ASN) located at θ1, θ2, θ3, . . . , θN, respectively. Assume that M is equal to 2, wherein the audio output devices 118 (FIG. 1) comprise two audio output device channels—CHl (left channel speaker) CHr (right channel speaker). Based on this example configuration, the audio content from each audio source (AS1 to ASN) is output to each of the two audio output device channels.

With regards to the distribution ratios, assume that the viewing angle is θ. Based on this, the left channel angle is θL=270+θ, and the right channel angle is θR=90+θ, where the respective magnitudes of each audio source (AS1 to ASN) for the left and right channels are calculated according to the following equations:

$$CHl = {\sum }_{i = 1}^{N} ASi \times fLi ( θ ) = {\sum }_{i = 1}^{N} ASi \times \frac{1 + cos ( θ L - θ i )}{2}$$

$$CHr = {\sum }_{i = 1}^{N} ASi \times fRi ( θ ) = {\sum }_{i = 1}^{N} ASi \times \frac{1 + cos ( θ R - θ i )}{2}$$

In the equations above, fLi(θ) represents the ratio for distributing the audio content from the i^{th} audio source (ASi) out of N audio sources to the left channel speaker based on a viewing angle θ degrees. Similarly, in the equations above, fRi(θ) represents the ratio for distributing the audio content from audio source ASi to the right channel speaker based on a viewing angle θ degrees, where the sum of the ratios is fLi(θ)+fRi(θ)=1. Thus, CHl represents the magnitude/volume of all audio signals from the N audio source (AS1 . . . ASNi) output to the left channel, while CHr(i) represents the magnitude/volume of all audio signals from all the N audio source (AS1 . . . ASNi) output to the right channel, where the audio signals are weighted by corresponding distribution ratios (fLi(θ),fRi(θ)). Thus, an improved audio experience is achieved by adjusting the perceived direction of audio according to the user's viewing angle during playback of 360 video, thereby providing the user with a more realistic experience.

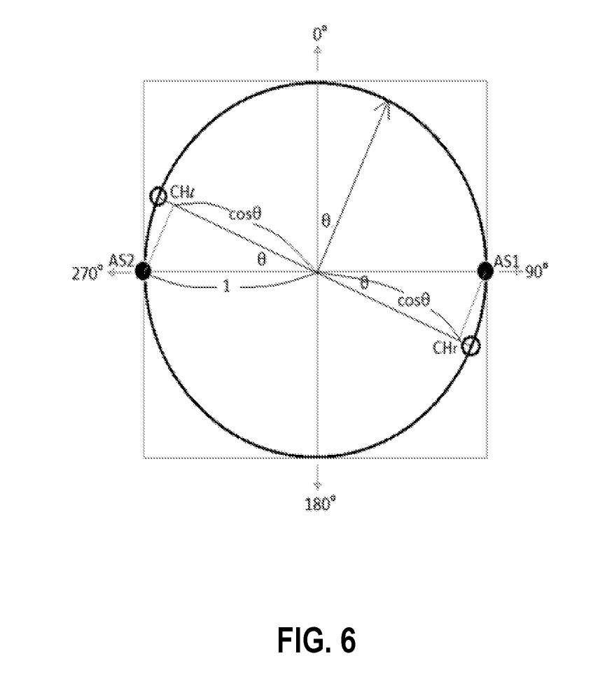

To further illustrate calculation of the distribution ratios disclosed above, reference is made to FIGS. 6-8, which illustrate calculation of the ratios for different viewing angles and for different numbers of audio sources (i.e., where the value of N varies). With reference to FIG. 6, assume that there are N=2 audio sources. Note that the audio sources AS1 and AS2 are not limited to being spaced apart by 180 degrees as the audio sources can be placed at any angle. However, for purposes of illustration, assume that AS1 is located at 90 degree (θ1=90) and AS2 is located at 270 degrees (θ2=270). The current viewing angle is θ, where θL=270+θ, and θR=90+θ. As discussed above, CHl(i) represents the magnitude/volume of audio source (i) output to the left channel, while CHr(i) represents the magnitude/volume of audio source (i) output to the right channel. These values are calculated for each of the N audio sources (i=1 to 2) based on the following equations:

$$CHl = \frac{1 - cos θ}{2} \times AS 1 + \frac{1 + cos θ}{2} \times AS 2$$

$$CHr = \frac{1 + cos θ}{2} \times AS 1 + \frac{1 - cos θ}{2} \times AS 2$$

Thus, if the viewing angle θ=0, then CHl=AS2 and CHr=AS1, whereas if the viewing angle θ=180, then CHl=AS1 and CHr=AS2. If the viewing angle θ=90, then CHl=½×AS1+½×AS2 and CHr=½×AS1+½×AS2. That is, for this particular example, the two audio sources (AS1, AS2) contribute equally when the viewing angle θ=90.

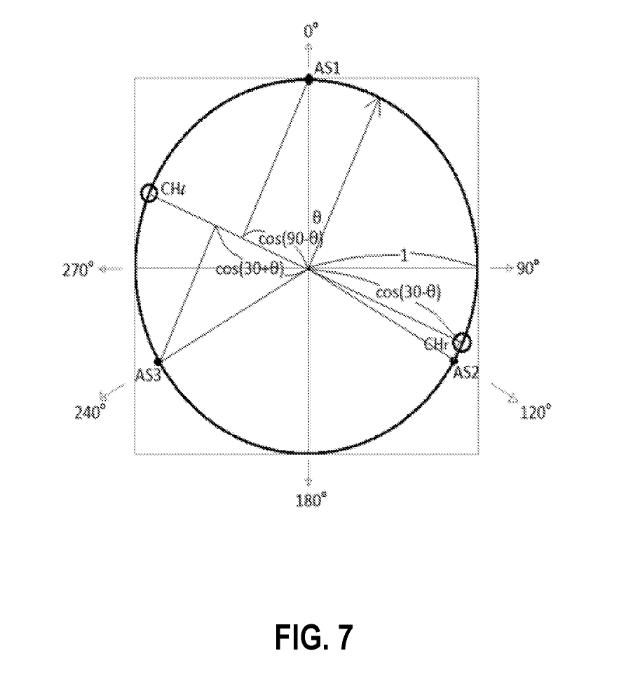

With reference to FIG. 7, assume that there are N=3 audio sources. For this example, assume that AS1 is located at 0 degree (θ1=0), AS2 is located at 120 degrees (θ2=120), and AS3 is located at 240 degrees (θ3=240), where the current viewing angle is θ such that θL=270+θ, θR=90+θ. The values for CHl and CHr are calculated for each of the N audio sources (i=1 to 3) based on the following equations:

$$CHl = \frac{1 + cos ( 90 - θ )}{2} \times AS 1 + \frac{1 - cos ( 30 - θ )}{2} \times AS 2 + \frac{1 + cos ( 30 + θ )}{2} \times AS 3$$

$$CHr = \frac{1 - cos ( 90 - θ )}{2} \times AS 1 + \frac{1 + cos ( 30 - θ )}{2} \times AS 2 + \frac{1 - cos ( 30 + θ )}{2} \times AS 3$$

Thus, if the viewing angle θ=0, then:

$$CHl = \frac{1}{2} \times AS 1 + \frac{2 - \sqrt{3}}{4} \times AS 2 + \frac{2 + \sqrt{3}}{4} \times AS 3$$

$$CHr = \frac{1}{2} \times AS 1 + \frac{2 + \sqrt{3}}{4} \times AS 2 + \frac{2 - \sqrt{3}}{4} \times AS 3$$

If the viewing angle θ=180, then:

$$CHl = \frac{1}{2} \times AS 1 + \frac{2 + \sqrt{3}}{4} \times AS 2 + \frac{2 - \sqrt{3}}{4} \times AS 3$$

$$CHr = \frac{1}{2} \times AS 1 + \frac{2 - \sqrt{3}}{4} \times AS 2 + \frac{2 + \sqrt{3}}{4} \times AS 3$$

If the viewing angle θ=90, then:

CHl=AS1+¼×AS2+¼×AS3

CHr=¾×AS2+¾×AS3

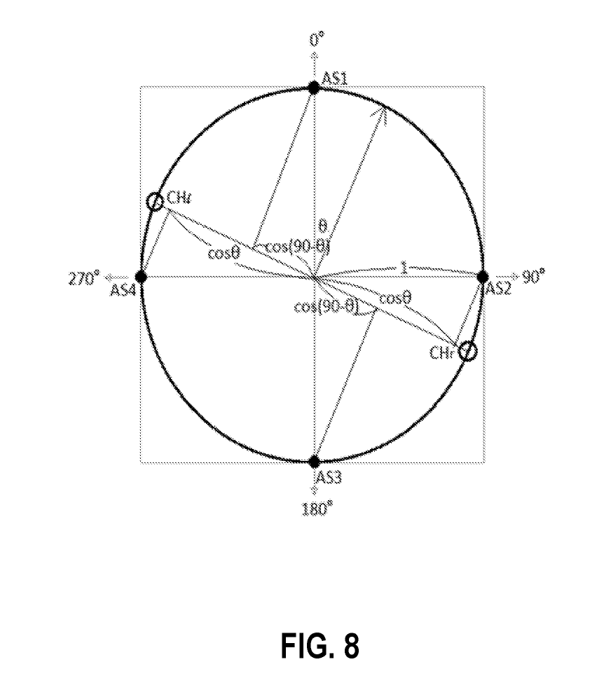

With reference to FIG. 8, assume that there are N=4 audio sources. For this example, assume that AS1 is located at 0 degree (θ1=0), AS2 is located at 90 degrees (θ2=90), AS3 is located at 180 degrees (θ3=180), AS4 is located at 270 degrees (θ4=270), where the viewing angle is θ such that θL=270+θ and θR=90+θ. The values for CHl and CHr are calculated for each of the N audio sources (i=1 to 4) based on the following equations:

$$CHl = \frac{1 + cos ( 90 - θ )}{2} \times AS 1 + \frac{1 - cos θ}{2} \times AS 2 + \frac{1 - cos ( 90 - θ )}{2} \times AS 3 + \frac{1 + cos θ}{2} \times AS 4$$

$$CHr = \frac{1 - cos ( 90 - θ )}{2} \times AS 1 + \frac{1 + cos θ}{2} \times AS 2 + \frac{1 + cos ( 90 - θ )}{2} \times AS 3 + \frac{1 - cos θ}{2} \times AS 4$$

Thus, if viewing angle θ=0, then:

CHl=½×AS1+½×AS3+AS4

CHr=½×AS1+AS2+½×AS3

If the viewing angle θ=180, then:

CHl=½×AS1+AS2+½×AS3

CHr=½×AS1+½×AS3+AS4

If the viewing angle θ=90, then:

CHl=AS1+½×AS2+½×AS4

CHr=½×AS2+AS3+½×AS4

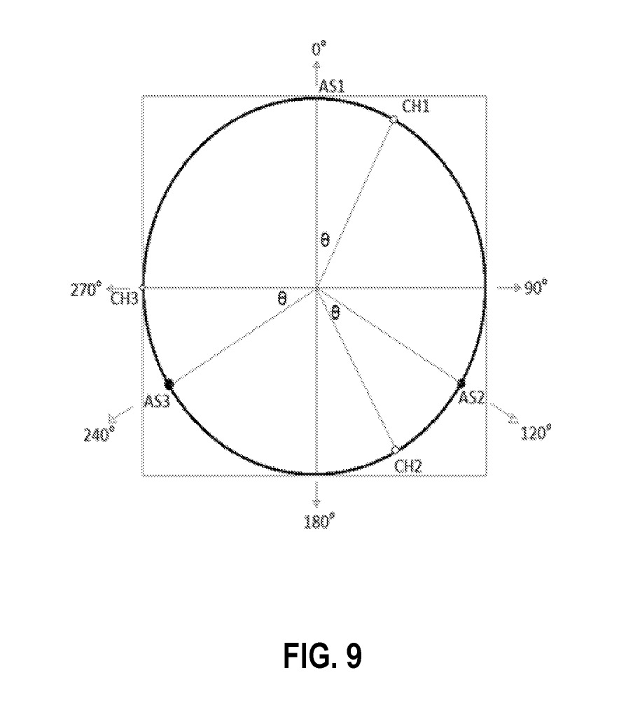

Note that while the audio output device (FIG. 1) has been described as two channels, the audio adjustment algorithm disclosed herein may be expanded to distribute audio content from N audio sources to M channels, where M is greater than 2, thereby achieving an even more realistic experience for the user. For example, if the user is standing closer to AS1, then the magnitude will be larger, and vice versa if the user is standing farther away from AS1. For embodiments where N audio sources are distributed to M channels (where M is greater than 2), consider the following example. Reference is made to FIG. 9. In this example, assume that there are 3 audio sources (N=3) comprising AS1, AS2, AS3, where AS1 is located at 0 degrees, AS2 is located at 120 degrees, and AS3 is located at 240 degrees. Assume for purposes of illustration that there are 3 audio output speakers (M=3) comprising CH1, CH2, CH3, where CH1 is located at θ degrees, CH2 is located at 120+θ degrees, CH3 is located at 240+θ degrees. If the current viewing angle is θ, then:

$$CH 1 = \frac{\frac{1}{min ( θ , 360 - θ )}}{\begin{matrix}\frac{1}{min ( θ , 360 - θ )} + \\ \frac{1}{min ( 120 + θ , 240 - θ )} + \frac{1}{min ( 240 + θ , 120 - θ )}\end{matrix}} \times AS 1 + \frac{\frac{1}{min ( 120 - θ , 240 + θ )}}{\begin{matrix}\frac{1}{min ( 120 - θ , 240 + θ )} + \\ \frac{1}{min ( θ , 360 - θ )} + \frac{1}{min ( 120 + θ , 240 - θ )}\end{matrix}} \times AS 2 + \frac{\frac{1}{min ( 240 - θ , 120 + θ )}}{\begin{matrix}\frac{1}{min ( 240 - θ , 120 + θ )} + \\ \frac{1}{min ( 120 - θ , 240 + θ )} + \frac{1}{min ( θ , 360 - θ )}\end{matrix}} \times AS 3$$

$$CH 2 = \frac{\frac{1}{min ( 120 + θ , 240 - θ )}}{\begin{matrix}\frac{1}{min ( θ , 360 - θ )} + \\ \frac{1}{min ( 120 + θ , 240 - θ )} + \frac{1}{min ( 240 + θ , 120 - θ )}\end{matrix}} \times AS 1 + \frac{\frac{1}{min ( θ , 360 - θ )}}{\begin{matrix}\frac{1}{min ( 120 - θ , 240 + θ )} + \\ \frac{1}{min ( θ , 360 - θ )} + \frac{1}{min ( 120 + θ , 240 - θ )}\end{matrix}} \times AS 2 + \frac{\frac{1}{min ( 120 - θ , 240 + θ )}}{\begin{matrix}\frac{1}{min ( 240 - θ , 120 + θ )} + \\ \frac{1}{min ( 120 - θ , 240 + θ )} + \frac{1}{min ( θ , 360 - θ )}\end{matrix}} \times AS 3$$

$$CH 3 = \frac{\frac{1}{min ( 240 + θ , 120 - θ )}}{\begin{matrix}\frac{1}{min ( θ , 360 - θ )} + \\ \frac{1}{min ( 120 + θ , 240 - θ )} + \frac{1}{min ( 240 + θ , 120 - θ )}\end{matrix}} \times AS 1 + \frac{\frac{1}{min ( 120 + θ , 240 - θ )}}{\begin{matrix}\frac{1}{min ( 120 - θ , 240 + θ )} + \\ \frac{1}{min ( θ , 360 - θ )} + \frac{1}{min ( 120 + θ , 240 - θ )}\end{matrix}} \times AS 2 + \frac{\frac{1}{min ( θ , 360 - θ )}}{\begin{matrix}\frac{1}{min ( 240 - θ , 120 + θ )} + \\ \frac{1}{min ( 120 - θ , 240 + θ )} + \frac{1}{min ( θ , 360 - θ )}\end{matrix}} \times AS 3$$

If θ=0, then CH1=AS1, CH2=AS2, CH3, =AS3.
If θ=120, then CH1=AS2, CH2=AS3, CH3, =AS1
If θ=240, then CH1=AS3, CH2=AS1, CH3, =AS2
If θ=30, then:

$$CH 1 = \frac{15}{23} \times AS 1 + \frac{5}{23} \times AS 2 + \frac{3}{23} \times AS 3 , \\ CH 2 = \frac{3}{23} \times AS 1 + \frac{15}{23} \times AS 2 + \frac{5}{23} \times AS 3 , \\ CH 3 = \frac{5}{23} \times AS 1 + \frac{3}{23} \times AS 2 + \frac{15}{23} \times AS 3$$

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

At least the following is claimed:

1. A method implemented in a computing device for adjusting audio output during playback of 360 video, comprising:
receiving a 360 video bitstream;
separating the 360 video bitstream into video content and audio content;
decoding the audio content corresponding to a plurality of audio sources, wherein a number of audio sources is represented by N;
displaying the video content and outputting the audio content through a plurality of output devices, wherein a number of output devices is represented by M;
in response to detecting a change in a viewing angle for the video content:
determining, for each of the plurality of output devices, a distribution ratio for each of the plurality of audio sources based on the viewing angle such that N×M distribution ratios are determined; and
outputting the audio content through each of the plurality of output devices based on the determined N×M distribution ratios.

2. The method of claim 1, wherein detecting the change in the viewing angle for the video content comprises detecting input from at least one of: a mouse, a touchscreen, a virtual-reality headset, and an accelerometer.

3. The method of claim 1, wherein outputting the audio content through each of the plurality of output devices based on the determined N×M distribution ratios comprises:
generating, for each of the plurality of output devices, a magnitude for outputting audio content corresponding to each of the plurality of audio sources based on the N×M distribution ratios such that N×M magnitudes are adjusted;
outputting the audio content corresponding to each of the plurality of audio sources through each of the plurality of output devices based on the N×M magnitudes.

4. The method of claim 1, wherein M is equal to 2, and wherein the output devices comprises a left channel output device and a right channel output device.

5. The method of claim 4, wherein the distribution ratios for the N audio sources for the left channel output device are determined according to:
$$\frac{1 + cos ( θ L - θ i )}{2} , for i = 1 to N$$
wherein θ represents the viewing angle, wherein θL=270+θ, and wherein the distribution ratios for the for the N audio sources for the right channel output device are determined according to:
$$\frac{1 + cos ( θ R - θ i )}{2} , for i = 1 to N$$
wherein θR=90+θ.

6. The method of claim 4, wherein the N×M magnitudes are generated according to:
$$CHl = {\sum }_{i = 1}^{N} ASi \times fLi ( θ ) = {\sum }_{i = 1}^{N} ASi \times \frac{1 + cos ( θ L - θ i )}{2}$$
$$CHr = {\sum }_{i = 1}^{N} ASi \times fRi ( θ ) = {\sum }_{i = 1}^{N} ASi \times \frac{1 + cos ( θ R - θ i )}{2}$$
wherein N represents the number of audio sources, wherein θ represents the viewing angle, wherein θL=270+θ and θR=90+θ, wherein CHl represents the audio content output through the left channel output device and CHr represents the audio content output through the right channel output device, wherein ASi represents an audio content for the i^{th} audio source, wherein fLi( ) represents the distribution ratio for the left channel output device, and wherein fRi( ) represents the distribution ratio for the right channel output device.

7. The method of claim 1, wherein M is greater than 2, and wherein the output devices comprise multiple channels.

8. A system, comprising:
a memory storing instructions; and
a processor coupled to the memory and configured by the instructions to at least:
receive a 360 video bitstream;
separate the 360 video bitstream into video content and audio content;
decode the audio content corresponding to a plurality of audio sources, wherein a number of audio sources is represented by N;
display the video content and output the audio content through a plurality of output devices, wherein a number of output devices is represented by M;
in response to detecting a change in a viewing angle for the video content:
determine, for each of the plurality of output devices, a distribution ratio for each of the plurality of audio sources based on the viewing angle such that N×M distribution ratios are determined; and
output the audio content through each of the plurality of output devices based on the determined N×M distribution ratios.

9. The system of claim 8, wherein detecting the change in the viewing angle for the video content comprises detecting input from at least one of: a mouse, a touchscreen, a virtual-reality headset, and an accelerometer.

10. The system of claim 8, wherein outputting the audio content through each of the plurality of output devices based on the determined N×M distribution ratios comprises:
generating, for each of the plurality of output devices, a magnitude for outputting audio content corresponding to each of the plurality of audio sources based on the N×M distribution ratios such that N×M magnitudes are adjusted;
outputting the audio content corresponding to each of the plurality of audio sources through each of the plurality of output devices based on the N×M magnitudes.

11. The system of claim 8, wherein M is equal to 2, and wherein the output devices comprises a left channel output device and a right channel output device.

12. The system of claim 11, wherein the distribution ratios for the N audio sources for the left channel output device are determined according to:
$$\frac{1 + cos ( θ L - θ i )}{2} , for i = 1 to N$$
wherein θ represents the viewing angle, wherein θL=270+θ, and wherein the distribution ratios for the for the N audio sources for the right channel output device are determined according to:
$$\frac{1 + cos ( θ R - θ i )}{2} , for i = 1 to N$$
wherein θR=90+θ.

13. The system of claim 11, wherein the N×M magnitudes are generated according to:
$$CHl = {\sum }_{i = 1}^{N} ASi \times fLi ( θ ) = {\sum }_{i = 1}^{N} ASi \times \frac{1 + cos ( θ L - θ i )}{2}$$
$$CHr = {\sum }_{i = 1}^{N} ASi \times fRi ( θ ) = {\sum }_{i = 1}^{N} ASi \times \frac{1 + cos ( θ R - θ i )}{2}$$
wherein N represents the number of audio sources, wherein θ represents the viewing angle, wherein θL=270+θ and θR=90+θ, wherein CHl represents the audio content output through the left channel output device and CHr represents the audio content output through the right channel output device, wherein ASi represents an audio content for the i^{th} audio source, wherein fLi( ) represents the distribution ratio for the left channel output device, and wherein fRi( ) represents the distribution ratio for the right channel output device.

14. The system of claim 8, wherein M is greater than 2 and wherein the output devices comprise multiple channels.

15. A non-transitory computer-readable storage medium storing instructions to be implemented by a computing device having a processor, wherein the instructions, when executed by the processor, cause the computing device to at least:
receive a 360 video bitstream;
separate the 360 video bitstream into video content and audio content;
decode the audio content corresponding to a plurality of audio sources, wherein a number of audio sources is represented by N;
display the video content and output the audio content through a plurality of output devices, wherein a number of output devices is represented by M;
in response to detecting a change in a viewing angle for the video content:
determine, for each of the plurality of output devices, a distribution ratio for each of the plurality of audio sources based on the viewing angle such that N×M distribution ratios are determined; and
output the audio content through each of the plurality of output devices based on the determined N×M distribution ratios.

16. The non-transitory computer-readable storage medium of claim 15, wherein detecting the change in the viewing angle for the video content comprises detecting input from at least one of: a mouse, a touchscreen, a virtual-reality headset, and an accelerometer.

17. The non-transitory computer-readable storage medium of claim 15, wherein outputting the audio content through each of the plurality of output devices based on the determined N×M distribution ratios comprises:
generating, for each of the plurality of output devices, a magnitude for outputting audio content corresponding to each of the plurality of audio sources based on the N×M distribution ratios such that N×M magnitudes are adjusted;
outputting the audio content corresponding to each of the plurality of audio sources through each of the plurality of output devices based on the N×M magnitudes.

18. The non-transitory computer-readable storage medium of claim 15, wherein M is equal to 2, and wherein the output devices comprises a left channel output device and a right channel output device.

19. The non-transitory computer-readable storage medium of claim 18, wherein the distribution ratios for the N audio sources for the left channel output device are determined according to:
$$\frac{1 + cos ( θ L - θ i )}{2} , for i = 1 to N$$
wherein θ represents the viewing angle, wherein θL=270+θ, and wherein the distribution ratios for the for the N audio sources for the right channel output device are determined according to:
$$\frac{1 + cos ( θ R - θ i )}{2} , for i = 1 to N$$
wherein θR=90+θ.

20. The non-transitory computer-readable storage medium of claim 18, wherein the N×M magnitudes are generated according to:
$$CHl = {\sum }_{i = 1}^{N} ASi \times fLi ( θ ) = {\sum }_{i = 1}^{N} ASi \times \frac{1 + cos ( θ L - θ i )}{2}$$
$$CHr = {\sum }_{i = 1}^{N} ASi \times fRi ( θ ) = {\sum }_{i = 1}^{N} ASi \times \frac{1 + cos ( θ R - θ i )}{2}$$
wherein N represents the number of audio sources, wherein θ represents the viewing angle, wherein θL=270+θ and θR=90+θ, wherein CHl represents the audio content output through the left channel output device and CHr represents the audio content output through the right channel output device, wherein ASi represents an audio content for the i^{th} audio source, wherein fLi( ) represents the distribution ratio for the left channel output device, and wherein fRi( ) represents the distribution ratio for the right channel output device.
